(19) United States
(12) Patent Application Publication
(10) Pub. No.: US 2025/0391397 A1
(43) Pub. Date: Dec. 25, 2025

(54) System and Method to Repeat Passwords Through a Secure Medium

(71) Applicant: Dell Products L.P., Round Rock, TX (US)

(72) Inventors: Sreenivasa Rao Manda, Bangalore (IN); Dinesh Kaarthick S, Bangalore (IN)

(73) Assignee: Dell Products L.P., Round Rock, TX (US)

(21) Appl. No.: 18/751,727

(22) Filed: Jun. 24, 2024

(51) Int. Cl. G10L 13/08; G06F 3/04817; G06F 21/31; G06F 21/60

(52) U.S. Cl. CPC G10L 13/08; G06F 3/04817; G06F 21/31; G06F 21/60

(57) ABSTRACT

An Information Handling System comprises a processor and a memory coupled to the processor. The memory has program instructions stored thereon that, upon execution by the processor, cause the IHS to receive a typed character string, obscure the character string on a display, present an audio icon on the display, convert the character string to spoken characters when the audio icon is selected by a user, and play the spoken characters to the user via a privacy-focused audio device. The privacy-focused audio device may be one or more of headphones or earbuds that are coupled to the IHS via a wired or wireless connection.

### BACKGROUND

As the value and use of information continues to increase, individuals and businesses seek additional ways to process and store information. One option available to users is Information Handling Systems (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Security risks associated with user devices, such as IHSs, can include a practice commonly referred to as shoulder surfing, wherein unauthorized individuals view a given user device without the knowledge and/or permission of the user of the user device. Certain situations can present increased vulnerability to shoulder surfing risks, such as situations involving individuals using user devices in crowded public spaces, individuals viewing confidential data on user devices, individuals working on sensitive projects on user devices, etc. Conventional device security approaches; however, face challenges in efficiently identifying unauthorized shoulder surfers and preventing unauthorized shoulder surfers from viewing sensitive and/or confidential data from user devices.

### SUMMARY

Embodiments are directed to an Information Handling System (IHS) comprising a processor and a memory coupled to the processor. The memory has program instructions stored thereon that, upon execution by the processor, cause the IHS to receive a typed character string, obscure the character string on a display, present an audio icon on the display, convert the character string to spoken characters when the audio icon is selected by a user, and play the spoken characters to the user via a privacy-focused audio device. The privacy-focused audio device may be one or more of headphones or earbuds that are coupled to the IHS via a wired or wireless connection. The privacy-focused audio device is configured to broadcast audio signals only to the user and to not broadcast audio signals publicly when the privacy-focused audio device is coupled to the IHS. The audio icon may be presented on the display only if the privacy-focused audio device is coupled to the IHS.

The character string may be a password. The IHS is configured to obscure the character string by replacing the character string with one or more placeholder characters. The placeholder characters may be asterisks, number signs, punctuation marks, or special characters. The audio icon may be a headphones icon, an ear icon, or a speaker icon.

The IHS may further present a visual icon on the display, and display the character string as readable text when the visual icon is selected by the user. The visual icon may be an eye icon, a glasses icon, or a text icon.

The IHS may further include a camera configured to capture images within a field of view. The field of view encompasses an area from which the character string may be observed on the display. The IHS may further process the images to determine a number of individuals within the field of view. If the number is two or more individuals, then the IHS prioritizes displaying the audio icon over the visual icon.

### BRIEF DESCRIPTION OF THE DRAWINGS

Having thus described the invention in general terms, reference will now be made to the accompanying drawings, which are not necessarily drawn to scale, and wherein:

FIG. 1 illustrates a block diagram depicting selected elements of an Information Handling System (IHS) in accordance with some embodiments of the present disclosure.

FIG. 2 illustrates an IHS device in the form of a laptop computer according to an example embodiment.

FIGS. 3A and 3B illustrate various user interfaces with alternative method for presenting password information to a user.

FIG. 4 illustrates a shoulder surfing problem when multiple users can see a user interface.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

The embodiments disclosed herein provide systems and methods to ensure that users have options to hear password text through a secure medium as an alternative to showing the password in clear text on screen. In today's digital era, the proliferation of applications and social media has led users to need many different passwords to access all the applications they utilize. For example, a user might have accounts for email and messenger services, social media, bank accounts, and work access that each require different password formats as defined in various password policies. At times, the user may need to reveal or view their passwords to verify the correct text when entering their credentials since the user might have doubts about the characters that were keyed in. In most of the user interfaces, a feature to reveal/show passwords is readily supported, thereby allowing users to view the characters they are typing into the password field. However, the existing password reveal/show feature exposes certain challenges, especially when users are in a public space and hesitate to use the feature due to the fear of passwords being overseen by people nearby.

By providing users with an alternate option to listen to their passwords via privacy-focused audio devices, such as headsets or earbuds, users can have confidence in the privacy of the password reveal feature, especially when they are in public spaces. The solution to listen to password text serves as a better alternative to the show password feature. Organizations and application developers can adopt the listen to password feature according to their needs.

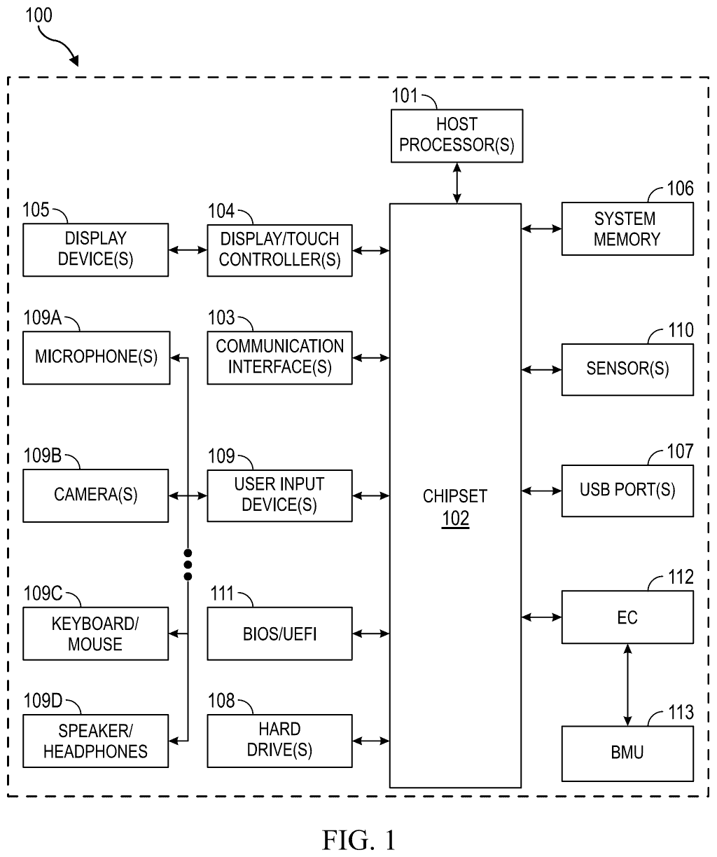

FIG. 1 illustrates a block diagram depicting selected elements of IHS 100 in accordance with some embodiments of the present disclosure. In various embodiments, IHS 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, IHS 100 may also represent other types of information handling systems, including desktop computers, server systems, controllers, and microcontroller units, among other types of information handling systems.

As depicted, IHS 100 includes host processor(s) 101. In various embodiments, IHS 100 may be a single-processor system, or a multi-processor system including two or more processors 101. Host processor(s) 101 may include any processor capable of executing program instructions, such as an INTEL/AMD x86 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like). Host processor(s) 101 may include any system, device, or apparatus operable to interpret and/or execute program instructions and/or process data, and may include a microprocessor, microcontroller, Digital Signal Processor (DSP), Application Specific Integrated Circuit (ASIC), or another digital or analog circuitry configured to interpret and/or execute program instructions and/or process data. In some embodiments, host processor(s) 101 may interpret and/or execute program instructions and/or process data stored locally (e.g., in system memory 106 and/or in another component of IHS 100) or stored remotely.

IHS 100 includes chipset 102 coupled to host processor(s) 101. Chipset 102 may provide host processor(s) 101 with access to several resources. In some cases, chipset 102 may utilize a QuickPath Interconnect (QPI) bus to communicate with host processor(s) 101. Chipset 102 may also be coupled to communication interface(s) 103 to enable communications between IHS 100 and various wired and/or wireless networks, such as Ethernet, WiFi, BT, cellular or mobile networks (e.g., Code-Division Multiple Access or “CDMA,” Time-Division Multiple Access or “TDMA,” Long-Term Evolution or “LTE,” etc.), satellite networks, or the like.

Communication interface(s) 103 may be used to communicate with peripheral devices (e.g., BT speakers, microphones, headsets, etc.). Moreover, communication interface(s) 103 may be coupled to chipset 102 via a Peripheral Component Interconnect Express (PCIe) bus, or the like.

Chipset 102 may be coupled to display and/or touchscreen controller(s) 104, which may include one or more Graphics Processor Units (GPUs) on a graphics bus, such as an Accelerated Graphics Port (AGP) or PCIe bus. As shown, display controller(s) 104 provide video or display signals to one or more display device(s) 105. Display device(s) 105 may include Liquid Crystal Display (LCD), Light Emitting Diode (LED), organic LED (OLED), or other thin film display technologies. Display device(s) 105 may include a plurality of pixels arranged in a matrix, configured to display visual information, such as text, two-dimensional images, video, three-dimensional images, etc. In some cases, display device(s) 105 may be provided as a single continuous display, rather than two discrete displays.

Chipset 102 may provide host processor(s) 101 and/or display controller(s) 104 with access to system memory 106. In various embodiments, system memory 106 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like. Alternatively, system memory 106 may comprise a system, device, or apparatus operable to retain and/or retrieve program instructions and/or data for a period of time (e.g., computer-readable media), such as electrically erasable programmable read-only memory (EEPROM), a PCMCIA card, flash memory, magnetic storage, opto-magnetic storage, and/or a suitable selection and/or array of volatile or non-volatile memory that retains data after power to IHS 100 is powered down.

In certain embodiments, chipset 102 may also provide host processor(s) 101 with access to one or more USB ports/controllers 107, to which one or more peripheral devices may be coupled (e.g., integrated or external webcams, microphones, speakers, etc.).

Chipset 102 may further provide host processor(s) 101 with access to one or more hard disk drives, solid-state drives, optical drives, or other removable-media drives 108.

Chipset 102 may also provide access to one or more user input devices 109, for example, using a super I/O controller or the like. Examples of user input devices 109 include, but are not limited to, microphone(s) 109a, camera(s) 109b, keyboard/mouse 109c, and speakers/headphones 109d. Other user input devices 109 may include a touchpad, stylus or active pen, totem, etc. Each user input device 109 may include a respective controller (e.g., a touchpad may have its own touchpad controller) that interfaces with chipset 102 through a wired or wireless connection (e.g., via communication interfaces(s) 103).

In some cases, chipset 102 may also provide access to one or more user output devices (e.g., video projectors, paper printers, 3D printers, loudspeakers, audio headsets, Virtual/Augmented Reality (VR/AR) devices, etc.).

In certain embodiments, chipset 102 may further provide an interface for communications with one or more hardware sensors 110. Sensors 110 may be disposed on or within the chassis of IHS 100, or otherwise coupled to IHS 100, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

BIOS/UEFI 111 is coupled to chipset 102. UEFI was designed as a successor to BIOS, and many modern IHSs utilize UEFI in addition to or instead of a BIOS. Accordingly, BIOS/UEFI 111 is intended to also encompass a UEFI component. BIOS/UEFI 111 provides an abstraction layer that allows the OS to interface with certain hardware components that are utilized by IHS 100.

Upon booting of IHS 100, host processor(s) 101 may utilize program instructions of BIOS 111 to initialize and test hardware components coupled to IHS 100, and to load a host OS for use by IHS 100. Via the hardware abstraction layer provided by BIOS/UEFI 111, software stored in system memory 106 and executed by host processor(s) 101 can interface with I/O devices coupled to IHS 100.

Embedded Controller (EC) 112 (sometimes referred to as a Baseboard Management Controller or “BMC”) includes a microcontroller unit or processing core dedicated to handling selected IHS operations not ordinarily handled by host processor(s) 101. Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes or “LEDs” (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 100, EC 112 may be made operational from the very start of each power reset, before other devices are fully running or powered on. As such, EC 112 may be responsible for interfacing with a power adapter to manage the power consumption of IHS 100. These operations may be utilized to determine the power status of IHS 100, such as whether IHS 100 is operating from battery power or is plugged into an AC power source. Firmware instructions utilized by EC 112 may be used to manage other core operations of IHS 100 (e.g., turbo modes, maximum operating clock frequencies of certain components, etc.).

In some cases, EC 112 may implement operations for detecting certain changes to the physical configuration or posture of IHS 100 and managing other devices in different configurations of IHS 100. For instance, when IHS 100 as a 2-in-1 laptop/tablet form factor, EC 112 may receive inputs from a lid position or hinge angle sensor 110, and it may use those inputs to determine: whether the two sides of IHS 100 have been latched together to a closed position or a tablet position, the magnitude of a hinge or lid angle, etc. In response to these changes, the EC may enable or disable certain features of IHS 100 (e.g., front or rear facing camera, etc.).

In some implementations, EC 112 may be installed as a Trusted Execution Environment (TEE) component to the motherboard of IHS 100. Additionally, or alternatively, EC 112 may be further configured to calculate hashes or signatures that uniquely identify individual components of IHS 100. In such scenarios, EC 112 may calculate a hash value based on the configuration of a hardware and/or software component coupled to IHS 100. For instance, EC 112 may calculate a hash value based on all firmware and other code or settings stored in an onboard memory of a hardware component.

Hash values may be calculated as part of a trusted process of manufacturing IHS 100 and may be maintained in secure storage as a reference signature. EC 112 may later recalculate the hash value for a component may compare it against the reference hash value to determine if any modifications have been made to the component, thus indicating that the component has been compromised. As such, EC 112 may validate the integrity of hardware and software components installed in IHS 100.

In addition, EC 112 may provide an Out-of-Band communication channel that allows an Information Technology Decision Maker (ITDM) or Original Equipment Manufacturer (OEM) to manage IHS 100's various settings and configurations, for example, by issuing OOB commands.

In various embodiments, IHS 100 may be coupled to an external power source through an AC adapter, power brick, or the like. The AC adapter may be removably coupled to a battery charge controller to provide IHS 100 with a source of DC power provided by battery cells of a battery system in the form of a battery pack (e.g., a lithium ion or “Li-ion” battery pack, or a nickel metal hydride or “NiMH” battery pack including one or more rechargeable batteries).

Battery Management Unit (BMU) 113 may be coupled to EC 112 and it may include, for example, an Analog Front End (AFE), storage (e.g., non-volatile memory), and a microcontroller. In some cases, BMU 113 may be configured to collect and store information, and to provide that information to other IHS components.

Examples of information collectible by BMU 113 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc.

In some embodiments, IHS 100 may not include all the components shown in FIG. 1. Furthermore, some components that are represented as separate components in FIG. 1 may instead be integrated with other components, such that all or a portion of the operations executed by the illustrated components may instead be executed by the integrated component.

For example, in various embodiments described herein, host processor(s) 101 and/or other components shown in FIG. 1 (e.g., chipset 102, display controller(s) 104, communication interface(s) 103, EC 112, etc.) may be replaced by other devices. As such, IHS 100 may assume different form factors including, but not limited to: servers, workstations, desktops, laptops, appliances, video game consoles, tablets, smartphones, etc.

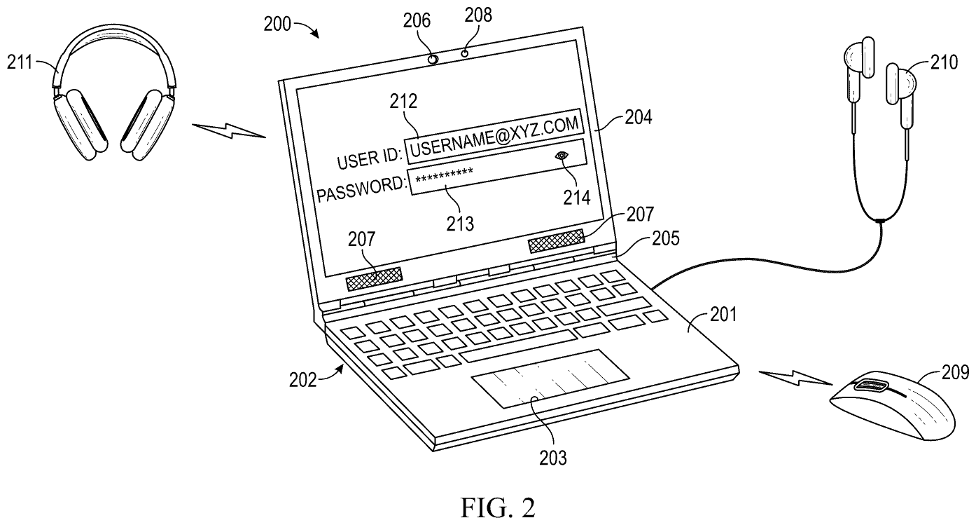

FIG. 2 illustrates an IHS device in the form of a laptop computer 200 according to an example embodiment. Laptop computer 200 has a bottom case 201 that holds a CPU, hard drive, memory, battery, motherboard, and other system components (e.g., similar to the components shown in FIG. 1). A keyboard 202 and trackpad 203 are included in the bottom case 201. A display screen 204 is attached to bottom case 201 by a hinge section 205. Laptop 200 may also have a built-in camera 206, speakers 207, and a microphone 208 to allow a user to interact with certain applications running on laptop 200.

Laptop 200 may be in connected to external devices to provide additional user interfaces. In addition to using trackpad 203, a wireless mouse 209 or other pointing device may be coupled to laptop 200. Internal and external speaker devices 109d, such as wired earbuds 210 or wireless headphones 211, may also be connected to laptop 200. The external speaker devices 210, 211 allow a user to privately listen to music or other audio messages from laptop 200. The wireless mouse 209 and wireless headphones 211 may communicate with laptop 200 using Bluetooth or a similar technology.

Typically, during start-up of laptop 200 or when logging in to applications running on laptop 200, the user will be prompted to enter credentials in the form of a user identifier (ID) 212 and password 213. Often, the user ID 212 is an email address or some version of the user's name. Password 213 usually has a defined structure requiring a minimum number of mixed characters including uppercase, lowercase, numbers, and special characters or symbols. The User ID 212 is usually displayed openly on screen 204; however, in many cases the password 213 defaults to an obscured presentation, such as a string of placeholder or generic symbols, such as asterisks or number signs (i.e., “*****” or “#####”), on screen 213 to protect the user's credentials and minimize inadvertent disclosure of password 213 to others. Because of the mixed-character requirement for password 213, it can be difficult for users to enter the correct combination and format of password characters while the text is obscured. Therefore, applications often have an option to allow users to display password 213 in clear text. This option is often represented by an icon, such as an eye 214. By “clicking on” or selecting the clear-text icon 214 (i.e., the “eye” icon), the user's password will be shown in clear text. In some cases, selection of the clear-text icon 214 will toggle the password between obscured symbols and clear text. However, when a user elects to view a password or other credentials in clear text, this defeats the purpose of the obscured text by allowing others (e.g., shoulder surfing observers) to view the user's password.

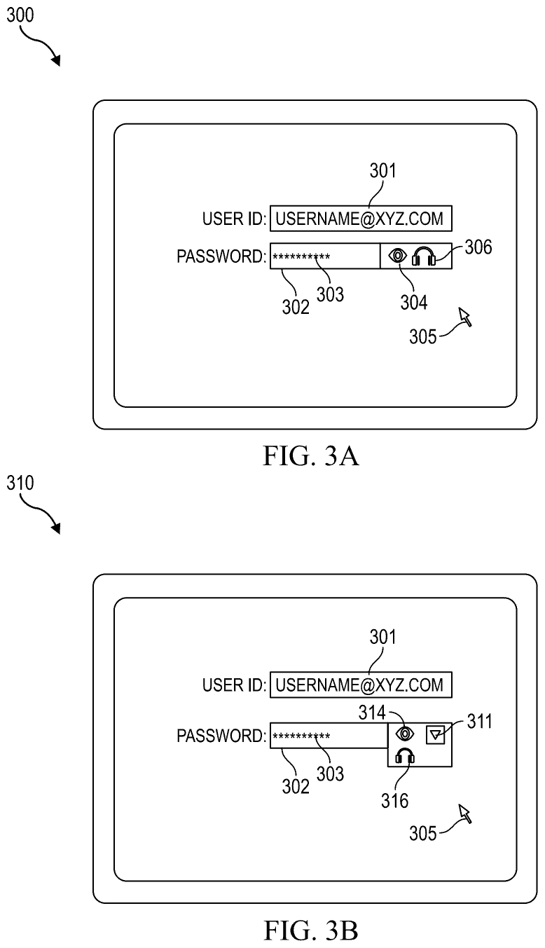

FIG. 3A illustrates a user interface 300, such as a display device 105 for a laptop, desktop, or tablet computer or other IHS device 100. User interface 300 provides an alternative method for presenting password information to a user. User interface 300, which shows a typical login screen for an application or website, provides a text box 301 for entering a user ID and a text box 302 for entering a user password. In the example illustrated in FIG. 3A, the password text 303 entered by the user is obscured. The user may elect to view the password in clear text by selecting the eye icon 304. The user may “click” the eye icon 304 using pointer 305, which may be controlled by a mouse or trackpad, for example.

User interface 300 also provides an alternative way to present the password text to the user. By selecting a headphone icon 306, instead of eye icon 304, the password text will remain obscured on the display 300 but will be spoken to the user via headphones or earbuds. For example, when headphone icon 306 is selected using pointer 305, the characters entered in password text box 302 will be spoken to the user via earbuds 210 or wireless headphones 211 (FIG. 2). In one embodiment, a text-to-speech application running on an IHS device 100 (FIG. 1) may be used to convert the characters entered in password text box 302 to spoken words. Accordingly, for the password text “Password01!” the user may hear the characters spoken phonetically as “uppercase pee, ay, ess, ess, double-u, oh, ar, dee, zero, one, exclamation point.” Instead of referring to designating capital letters as “uppercase,” in some embodiments, capital letters may be described as “cap” or “capital” (e.g., “cap pee” for the password example above). Alternatively, each letter may be audibly noted as uppercase or lowercase (i.e., instead of just highlighting the uppercase letters). In another embodiment, if the password text includes recognizable words (i.e., in a standard dictionary), then the password may be spoken using the words, such as “password, zero, one, exclamation point.”

The headphone icon 306 may be selected before the password text is entered, in which case each character will be spoken to the user via headphones or earbuds as the character is entered. Alternatively, in other embodiments, if the password text has been entered before the headphone icon 306 is selected, then all of the previously entered password characters will be spoken at once.

As shown in FIG. 3A, both the eye icon 304 and the headphone icon 306 are displayed at the same time and both are available for selection. FIG. 3B illustrates an alternative embodiment in which the eye icon 314 and headphone icon 316 are selected via a dropdown menu. For example, if drop down arrow 311 is selected, then the eye icon 314 and headphone icon 316 are displayed and are selectable.

The examples illustrated herein use an eye icon 304 and a headphone icon 306 to represent displaying the password in clear text or playing spoken password characters, respectively. It will be understood that, in other embodiments, other icons may be used, such as a glasses or text (e.g., “ABC”) icon in place of eye icon 304 or an ear or speaker icon in place of headphones icon 306.

In some configurations, in order to ensure privacy of the password text, the IHS device 100 determines whether headphones or earbuds are attached to the device before offering the spoken password option. That is, the headphone icon 304 is only presented as a user password option when headphones or earbuds are detected. This would ensure that the spoken password is only heard by the user wearing headphones or earbuds. In other configurations, the spoken password may be available whenever any type of speaker is detected by the IHS device, including an eternal speaker or speaker that broadcasts to anyone in the vicinity of the IHS device. Although, having the password spoken via a speaker (instead of headphones) risks having the password overheard by others, there are some situations in which speaking characters may be useful to clarify what characters were entered. For example, while the lowercase letter “l” is visually similar to the number “1” and the uppercase letter “O” is visually similar to the number “0,” it would be obvious which character is which when those characters are spoken.

Existing operating systems offer screen reader and text-to-speech functionality to assist visually impaired users. For example, the Windows 10 and 11 operating systems from Microsoft include the Narrator feature. Generally, Microsoft's Narrator will speak text as it is typed; however, in the case of obscured passwords, Narrator will not speak the password characters. Instead, a password is being typed and the characters are obscured (i.e., replaced with asterisks 303), Narrator will describe those characters as “bullet, bullet, bullet, . . . ” and will not announce the actual underlying characters. In some cases, if the password is preloaded, then Narrator may simply announce the password text as “hidden.” Accordingly, existing screen reader functionality does not support reading obscured password text to users.

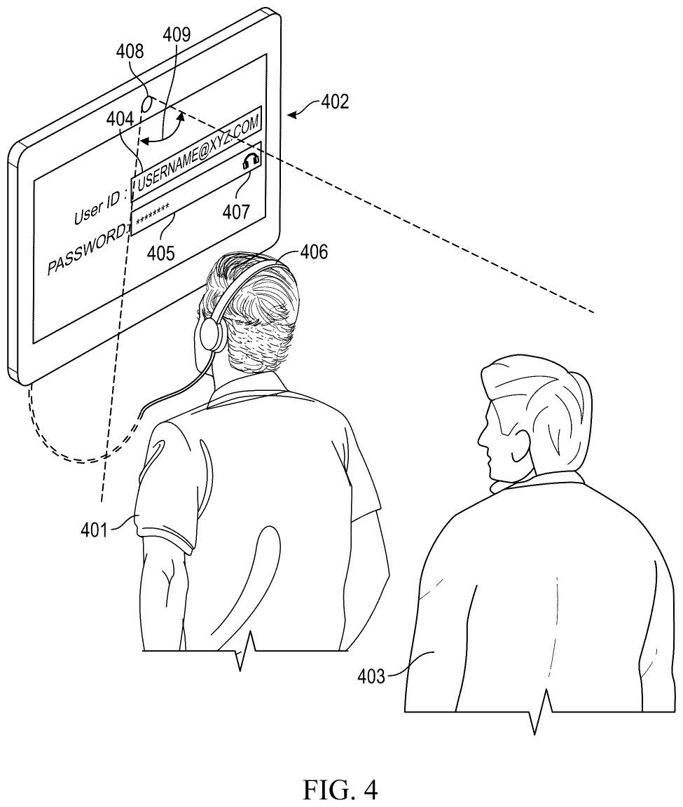

FIG. 4 illustrates the shoulder surfing problem and an example configuration for addressing that problem. A user 401 accesses an IHS system having a display 402. An observer 403 is behind or near user 401 and is also able to see display 402. Accordingly, if user 401 enters user ID text in field 404 and password text in field 405, then observer 403 will also see text in those fields by looking over the shoulder of user 401. Preferably, a default IHS configuration obscures the text in password field 405 so that an observer 403 cannot see the actual password characters. User 401 is wearing headphones 406. As noted herein, the password characters may be replaced with asterisks or other placeholder or generic characters on display 402; however, user 401 may select headphones icon 407, which will cause the IHS device to speak the password characters to user 401 via headphones 406 so that observer 403 cannot hear or see the password characters.

In one embodiment, only when the IHS device detects that headphones 406, earbuds, or other single-user audio device is attached, then it will display headphone icon 407 as an option to speak the password characters. In this embodiment, the headphone icon 407 will not be displayed when a single-user audio device, such as headphones 406, is not detected. This will prevent the user 401 from accidently having the password characters read aloud via a system speaker or external speaker that may be overheard by observer 403. Alternatively, in other configurations, the headphones icon 407 may be displayed whether or not a single-user audio device is detected so that the password text may be spoken over any speaker attached to the IHS device, which may result in the password text being broadcast to more people than just user 401. In this disclosure, single-user audio device is intended to mean headphones, earbuds, or any similar device that limits broadcasting of IHS-generated audio to a single person. In some configurations, multiple single-user audio devices may be connected to the IHS device, which would allow multiple authorized users to hear IHS-generated audio, including spoken password characters.

An IHS device may have a camera 109b, such as camera 408 on display 402. Camera 408 has a field of view 409. It may be assumed that people within the field of view 409 of camera 408 can see content on display 402. In one embodiment, camera 408 may detect both user 401 and observer 403, which can be interpreted to mean that both individuals 401, 403 can see the user ID field 404 and the password field 405. In this situation, the IHS device may not offer an option to show password characters in clear text or may show that option as a second or third choice (i.e., an eye icon 304 may not be presented or may be listed after a headphone icon 306 on the user interface). This would prevent user 401 from inadvertently displaying password characters to observer 403. Instead, the headphone icon 306 may be the only option or may be listed before the eye icon 304 to encourage user 401 to have the password characters spoken privately (i.e., via headphones) instead of being displayed semi-publicly.

In an example arrangement, an Information Handling System (IHS), comprises a processor and a memory coupled to the processor. The memory stores program instructions that, upon execution by the processor, cause the IHS to receive a typed character string, obscure the character string on a display, present an audio icon on the display, convert the character string to spoken characters when the audio icon is selected by a user, and play the spoken characters to the user via a privacy-focused audio device.

The privacy-focused audio device may be one or more of headphones or earbuds that are coupled to the IHS via a wired or wireless connection. It will be understood that the privacy-focused audio device is not limited to headphones or earbuds but can include any device that plays audio signals directed to an IHS user without being publicly broadcast (e.g., via in-ear or on-ear speakers or via bone conduction). The privacy-focused audio device is generally configured to broadcast audio signals only to the user (e.g., the wearer). The IHS is configured to not broadcast audio signals publicly when the privacy-focused audio device is coupled to the IHS (e.g., IHS speakers are muted when headphones or earbuds are attached).

In some embodiments, the character string comprises letters, numbers, and other characters or punctuation marks. The character string may be, for example, a password, account number, user identification, or any other credentials or data required to access personal, business, or financial applications or information. The IHS may be configured to obscure the character string by replacing the character string with one or more placeholder characters. The placeholder characters may be, for example, asterisks, number signs, punctuation marks, or special characters. Alternatively, the items in the character string (i.e., the individual letters, numbers, etc.) may be displayed as blank spaces or blocks.

The audio icon may be, for example, selected from: a headphones icon, an ear icon, a speaker icon, or any other symbol, image, or figure suggesting audio transmission or privacy.

The IHS device program instructions may further cause the IHS to present a visual icon on the display, and display the character string as readable text when the user selects the visual icon. This allows the user to show the character string as clear text on the display instead of using placeholder characters. The visual icon may be, for example, an eye icon, a glasses icon, and a text icon.

The IHS device may further include a camera configured to capture images within a field of view. The field of view encompasses an area from which the character string may be observed on the display (i.e., the area in which a user would usually be positioned). The program instructions further cause the IHS to process the images to determine a number of individuals within the field of view. This processing may include, for example, an analysis of images to identify faces, bodies, or body parts and equating the identified faces, bodies, or body parts to a number of individuals. If the number of individuals is two or more, then the IHS prioritizes how the audio icon is presented on the display over how the visual icon is presented (e.g., the audio icon may be presented ahead of or above the visual icon or only the audio icon may be presented).

The IHS device program instructions may further cause the IHS to present the audio icon on the display only when the privacy-focused audio device is coupled to the IHS.

In another embodiment, a method comprises receiving a typed character string from a user at an IHS, obscuring the character string on a display so that the user cannot see one or more items within the character string, providing an audio icon on the display, converting the character string to spoken characters when the audio icon is selected by a user, and playing the spoken characters to the user via a privacy-focused audio device. The privacy-focused audio device may be one or more of headphones or earbuds that are coupled to the IHS via a wired or wireless connection. The privacy-focused audio device may be configured to broadcast audio signals only to the user. The IHS is configured to not broadcast audio signals publicly when the privacy-focused audio device is coupled to the IHS.

The character string is a password, and wherein the items comprise one or more of uppercase letters, lowercase letters, numbers, and special characters. Obscuring the character string may include replacing one or more items in the character string with one or more placeholder characters. The placeholder characters are asterisks, number signs, punctuation marks, or special characters.

The method may further include determining whether the privacy-focused audio device is coupled to the IHS and presenting the audio icon on the display only if the privacy-focused audio device is coupled to the IHS.

The method may further include presenting a visual icon on the display and displaying all of the items in the character string as readable text when the user selects the visual icon.

The method may further include capturing images within a field of view of a camera on the IHS, the field of view encompassing an area from which the character string may be observed on the display, processing the images to determine a number of individuals within the field of view, and if the number is two or more, then prioritizing presentation of the audio icon on the display over the visual icon.

For the purposes of this disclosure, an Information Handling System may include an instrumentality or combination of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer (e.g., laptop, desktop, tablet, etc.), a mobile telephone or smartphone, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or combination of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing. Such computer-readable media may store computer instructions (e.g., applications software) adapted to execute on a processor and to provide the services, process, and methods disclosed herein.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. An Information Handling System (IHS), comprising:
a processor; and
a memory coupled to the processor, the memory having program instructions stored thereon that, upon execution by the processor, cause the IHS to:
receive a typed character string;
obscure the character string on a display;
present an audio icon on the display;
convert the character string to spoken characters when the audio icon is selected by a user; and
play the spoken characters to the user via a privacy-focused audio device.

2. The IHS device of claim 1, wherein the privacy-focused audio device is one or more of headphones or earbuds that are coupled to the IHS via a wired or wireless connection.

3. The IHS device of claim 1, wherein the privacy-focused audio device is configured to broadcast audio signals only to the user, and wherein the IHS is configured to not broadcast audio signals publicly when the privacy-focused audio device is coupled to the IHS.

4. The IHS device of claim 1, wherein the character string is a password.

5. The IHS device of claim 1, wherein the IHS is configured to obscure the character string by replacing the character string with one or more placeholder characters.

6. The IHS device of claim 5, wherein the placeholder characters are asterisks, number signs, punctuation marks, or special characters.

7. The IHS device of claim 1, wherein the audio icon is selected from: a headphones icon, an ear icon, and a speaker icon.

8. The IHS device of claim 1, wherein the program instructions further cause the IHS to:
present a visual icon on the display; and
display the character string as readable text when the visual icon is selected by the user.

9. The IHS device of claim 8, wherein the visual icon is selected from: an eye icon, a glasses icon, and a text icon.

10. The IHS device of claim 8, further comprising:
a camera configured to capture images within a field of view, the field of view encompassing an area from which the character string may be observed on the display; and
the program instructions further cause the IHS to:
process the images to determine a number of individuals within the field of view; and
if the number is two or more, then prioritizing how the audio icon is presented on the display over how the visual icon is presented.

11. The IHS device of claim 1, wherein the program instructions further cause the IHS to:
present the audio icon on the display only if the privacy-focused audio device is coupled to the IHS.

12. A method, comprising:
receiving a typed character string from a user at an Information Handling System (IHS);
obscuring the character string on a display so that the user cannot see one or more items within the character string;
providing an audio icon on the display;
converting the character string to spoken characters when the audio icon is selected by a user; and
playing the spoken characters to the user via a privacy-focused audio device.

13. The method of claim 12, wherein the privacy-focused audio device is one or more of headphones or earbuds that are coupled to the IHS via a wired or wireless connection.

14. The method of claim 12, wherein the privacy-focused audio device is configured to broadcast audio signals only to the user, and wherein the IHS is configured to not broadcast audio signals publicly when the privacy-focused audio device is coupled to the IHS.

15. The method of claim 12, wherein the character string is a password, and wherein the items comprise one or more of uppercase letters, lowercase letters, numbers, and special characters.

16. The method of claim 12, wherein obscuring the character string comprises:
replacing one or more items in the character string with one or more placeholder characters.

17. The method of claim 16, wherein the placeholder characters are asterisks, number signs, punctuation marks, or special characters.

18. The method of claim 12, further comprising:
determining whether the privacy-focused audio device is coupled to the IHS; and
presenting the audio icon on the display only if the privacy-focused audio device is coupled to the IHS.

19. The method of claim 12, further comprising:
presenting a visual icon on the display; and
displaying all of the items in the character string as readable text when the visual icon is selected by the user.

20. The method of claim 19, further comprising:
capturing images within a field of view of a camera on the IHS, the field of view encompassing an area from which the character string may be observed on the display;
processing the images to determine a number of individuals within the field of view; and
if the number is two or more, then prioritizing presentation of the audio icon on the display over the visual icon.
